(19) United States
(12) Patent Application Publication
(10) Pub. No.: US 2016/0341938 A1
(43) Pub. Date: Nov. 24, 2016

(54) IMAGING LENS AND IMAGING APPARATUS

(71) Applicant: FUJIFILM Corporation, Tokyo (JP)

(72) Inventor: Ping SUN, Saitama-shi (JP)

(73) Assignee: FUJIFILM Corporation, Tokyo (JP)

(21) Appl. No.: 15/153,248

(22) Filed: May 12, 2016

(30) Foreign Application Priority Data
May 18, 2015 (JP) 2015-100836

(51) Int. Cl. G02B 13/04; G02B 27/00; G02B 9/64

(52) U.S. Cl. CPC G02B 13/04; G02B 9/64; G02B 27/0025

(57) ABSTRACT

An imaging lens includes, in order from the object side: a negative first lens group; a stop; and a positive second lens group. The first lens group includes, in order from the object side, a negative first sub lens group including one positive lens and three negative lenses, and a positive second sub lens group including at least two positive lenses and at least one negative lens. The second lens group includes, in order from the object side, a positive lens, a first cemented lens formed by cementing a negative lens, and a biconvex positive lens, provided in this order from the object side, together, and a second cemented lens formed by cementing a biconvex positive lens and a negative lens, provided in this order from the object side, together. Focusing operations are performed by moving only the second lens group.

### CROSS REFERENCE TO RELATED APPLICATIONS

The present application claims priority under 35 U.S.C. §119 to Japanese Patent Application No. 2015-100836 filed on May 18, 2015. The above application is hereby expressly incorporated by reference, in its entirety, into the present application.

### BACKGROUND

The present disclosure is related to an imaging lens which is favorably suited for use in electronic cameras, such as video cameras, cinema cameras, digital cameras, and surveillance cameras. The present disclosure is also related to an imaging apparatus equipped with this imaging lens.

Recently, cinema cameras and digital cameras are progressively becoming compatible with the 4K and 8K formats. There is demand for lenses which are compatible with a greater number of pixels and in which various aberrations are favorably corrected, as imaging lenses to be employed in such cameras.

An imaging lens for use in electronic cameras, such as cinema cameras, digital cameras, video cameras, and surveillance cameras, is disclosed in Japanese Unexamined Patent Publication No. 2004-245967. Japanese Unexamined Patent Publication No. 2004-245967 discloses an imaging lens having a two group (front group/rear group) configuration.

### SUMMARY

However, the imaging lens of Japanese Unexamined Patent Publication No. 2004-245967 does not sufficiently correct various aberrations, and the angle of view thereof is not very wide. Accordingly, there is demand for an imaging lens having a wide angle of view that favorably corrects various aberrations.

The present disclosure has been developed in view of the foregoing circumstances. The present disclosure provides a wide angle imaging lens in which various aberrations are favorably corrected, as well as an imaging apparatus equipped with such an imaging lens.

An imaging lens of the present disclosure consists of, in order from the object side to the image side:

a first lens group having a negative refractive power;

a stop; and

a second lens group having a positive refractive power;

the first lens group consisting of in order from the object side to the image side, a first sub lens group having a negative refractive power as a whole, consisting of one positive lens and three negative lenses, and a second sub lens group having a positive refractive power as a whole, including at least two positive lenses and at least one negative lens;

the second lens group including, in order from the object side to the image side, a positive lens, a first cemented lens formed by cementing a negative lens and a biconvex positive lens, provided in this order from the object side to the image side, together, and a second cemented lens formed by cementing a biconvex positive lens and a negative lens, provided in this order from the object side to the image side, together; and

focusing operations being performed by moving the second lens group while the first lens group and the stop are fixed with respect to an imaging surface.

Here, the expression “the second lens group including, in order from the object side to the image side, a positive lens, a first cemented lens formed by cementing a negative lens and a biconvex positive lens, provided in this order from the object side to the image side, together, and a second cemented lens formed by cementing a biconvex positive lens and a negative lens, provided in this order from the object side to the image side, together” not only refers to a lens group that includes other lenses toward the image side of the cluster of the positive lens, the first cemented lens, and the second cemented lens, but also to a lens group that includes other lenses at the object side of the three lenses/cemented lenses or between pairs from among the three lenses/cemented lenses.

In the imaging lens of the present disclosure, it is preferable for the second sub lens group to be constituted by five or fewer lenses.

In addition, it is preferable for the second lens group to be constituted by six or fewer lenses.

In addition, it is preferable for Conditional Formula (1) below to be satisfied. Note that it is more preferable for Conditional Formula (1-1) below to be satisfied.

5<-f1/f<39 (1)

6<-f/f<35 (1-1)

wherein f1 is the focal length of the first lens group, and f is the focal length of the entire lens system.

In addition, it is preferable for Conditional Formula (2) below to be satisfied. Note that it is more preferable for Conditional Formula (2-1) below to be satisfied.

1.5<-f1/f2<13 (2)

2<-f1/f2<12 (2-1)

wherein f1 is the focal length of the first lens group, and f2 is the focal length of the second lens group.

In addition, it is preferable for Conditional Formula (3) below to be satisfied. Note that it is more preferable for Conditional Formula (3-1) below to be satisfied.

1.2<(R5f+R5r)/(R5f−R5r)<6.5 (3)

1.3<(R5f+R5r)/(R5f−R5r)<6 (3-1)

wherein R5f is the radius of curvature of the surface toward the object side of the positive lens provided most toward the object side within the second sub lens group, and R5r is the radius of curvature of the surface toward the image side of the positive lens provided most toward the object side within the second sub lens group.

In addition, it is preferable for Conditional Formula (4) below to be satisfied. Note that it is more preferable for Conditional Formula (4-1) below to be satisfied.

6<f1/f1a<50 (4)

7<f1/f1a<44 (4-1)

wherein f1 is the focal length of the first lens group, and f1a is the focal length of the first sub lens group.

In addition, it is preferable for Conditional Formula (5) below to be satisfied. Note that it is more preferable for Conditional Formula (5-1) below to be satisfied.

3.1<-f2/f1a<3.75 (5)

3.2<-f2/f1a<3.65 (5-1)

wherein f2 is the focal length of the second lens group, and f1a is the focal length of the first sub lens group.

In addition, it is preferable for Conditional Formula (6) below to be satisfied. Note that it is more preferable for Conditional Formula (6-1) below to be satisfied.

3.4<(R2f+R2r)/(R2f−R2r)<6 (6)

3.4<(R2f+R2r)/(R2f−R2r)<5 (6-1)

wherein R2f is the radius of curvature of the surface toward the object side of the negative lens provided most toward the object side within the first sub lens group, and R2r is the radius of curvature of the surface toward the image side of the negative lens provided most toward the object side within the first sub lens group.

An imaging apparatus of the present disclosure is characterized by being equipped with the imaging lens of the present disclosure.

Note that the expression “consists of” means that the imaging lens may include lenses that practically do not have any power, optical elements other than lenses such as a stop, a mask, a cover glass, and a filter, and mechanical components such as lens flanges, a lens barrel, an imaging element, and a camera shake correcting mechanism, in addition to the component elements listed above.

In addition, the surface shapes, the radii of curvature, and the signs of the refractive powers of the above lenses are those which are considered in the paraxial region in the case that the lenses include aspherical surfaces.

The imaging lens of the present disclosure consists of in order from the object side to the image side: the first lens group having a negative refractive power; the stop; and the second lens group having a positive refractive power. The first lens group consists of, in order from the object side to the image side, the first sub lens group having a negative refractive power as a whole, consisting of one positive lens and three negative lenses, and the second sub lens group having a positive refractive power as a whole, including at least two positive lenses and at least one negative lens. The second lens group includes, in order from the object side to the image side, the positive lens, the first cemented lens formed by cementing a negative lens and a biconvex positive lens, provided in this order from the object side to the image side, together, and a second cemented lens formed by cementing a biconvex positive lens and a negative lens, provided in this order from the object side to the image side, together. Focusing operations are performed by moving the second lens group while the first lens group and the stop are fixed with respect to an imaging surface. Therefore, it is possible to configure the imaging lens to be that having a wide angle of view, and in which various aberrations are favorably corrected.

In addition, the imaging apparatus of the present disclosure is equipped with the imaging lens of the present disclosure. Therefore, the imaging apparatus of the present disclosure is capable of obtaining images having high image quality at wide angels of view.

### BRIEF DESCRIPTION OF THE DRAWINGS

FIG. 1 is a cross sectional diagram that illustrates the lens configuration of an imaging lens according to an embodiment of the present disclosure (common with Example 1).

FIG. 2 is a cross sectional diagram that illustrates the lens configuration of an imaging lens according to Example 2 of the present disclosure.

FIG. 3 is a cross sectional diagram that illustrates the lens configuration of an imaging lens according to Example 3 of the present disclosure.

FIG. 4 is a cross sectional diagram that illustrates the lens configuration of an imaging lens according to Example 4 of the present disclosure.

FIG. 5 is a collection of diagrams that illustrate aberrations of the imaging lens of Example 1 of the present disclosure.

FIG. 6 is a collection of diagrams that illustrate aberrations of the imaging lens of Example 2 of the present disclosure.

FIG. 7 is a collection of diagrams that illustrate aberrations of the imaging lens of Example 3 of the present disclosure.

FIG. 8 is a collection of diagrams that illustrate aberrations of the imaging lens of Example 4 of the present disclosure.

FIG. 9 is a diagram that schematically illustrates an imaging apparatus according to an embodiment of the present disclosure.

### DETAILED DESCRIPTION OF THE PREFERRED EMBODIMENTS

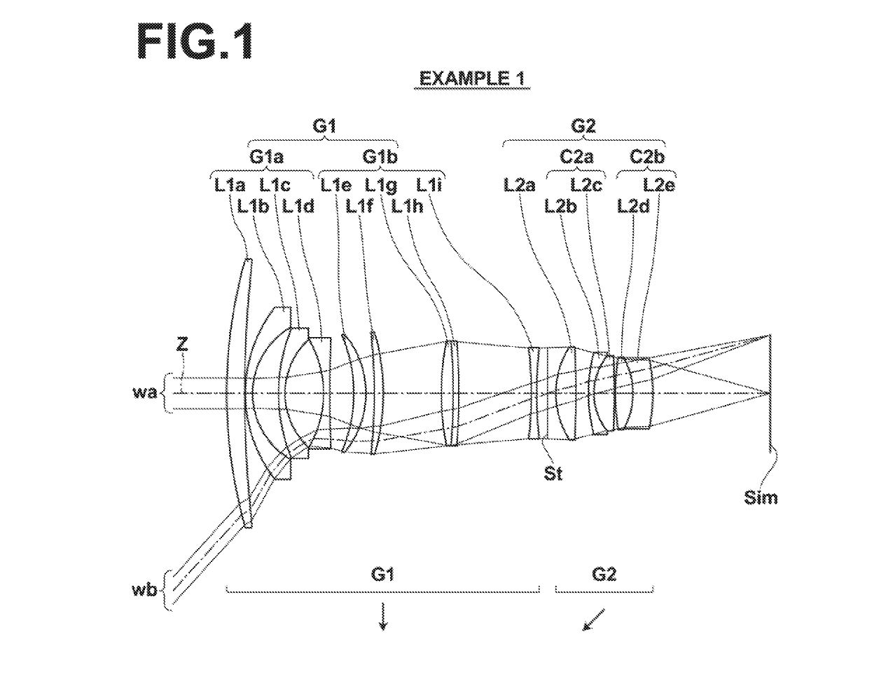

Hereinafter, embodiments of the present disclosure will be described in detail with reference to the attached drawings. FIG. 1 is a cross sectional diagram that illustrates the lens configuration of an imaging lens according to an embodiment of the present disclosure. The example of the configuration illustrated in FIG. 1 is common with the configuration of an imaging lens according to Example 1, which will be described later. FIG. 1 illustrates a lens system which is arranged in a state focused on an object at infinity. In FIG. 1, the left side is the object side, and the right side is the image side. The aperture stop St illustrated in FIG. 1 does not necessarily represent the size or shape thereof; but the position of the stop along an optical axis Z. In addition, FIG. 1 also illustrates an axial light beam wa and a light beam wb at a maximum angle of view.

As illustrated in FIG. 1, this imaging lens consists of, in order from the object side to the image side, a first lens group G1 having a negative refractive power, the aperture stop St, and a second lens group G2 having a positive refractive power. The imaging lens is configured to perform focusing operations by moving the second lens group G2 while the first lens G1 and the aperture stop St are fixed with respect to an imaging surface Sim.

Adopting a retro focus configuration, in which the arrangement of powers is asymmetrical with respect to the aperture stop St by the imaging lens being constituted by, in order form the object side to the image side, the first lens group G1 having a negative refractive power, the aperture stop St, and the second lens group G2 having a positive refractive power, is advantageous from the viewpoints of widening the angle of view and correcting astigmatism. In addition, fluctuations in astigmatism and distortion during focusing operations can be suppressed by the aperture stop St. The aperture stop St shielding light beams having large angles is also advantageous from the viewpoints of correcting longitudinal chromatic aberration and astigmatism. Further, a configuration in which only the second lens group G2 that does not include the aperture stop St is moved when focusing on objects at proximate distances can decrease the weight of focusing groups compared to a case in which the aperture stop is included or a plurality of lens groups are moved during focusing operations.

The first lens group G1 consists of; in order from the object side to the image side, a first sub lens group G1a having a negative refractive power as a whole, consisting of one positive lens and three negative lenses, and a second sub lens group having a positive refractive power as a whole, including at least two positive lenses and at least one negative lens.

Arranging one positive lens most toward the object side within the first sub lens group G1a is advantageous from the viewpoint of correcting distortion and lateral chromatic aberration. Arranging three negative lenses at the image side of the one positive lens enables the diameter of the lens system as a whole to be prevented from becoming excessively great, while suppressing spherical aberration and widening the angle of view. In addition, by the second sub lens group G1b being configured to have a positive refractive power, the positive refractive power of the second lens group G2 can be distributed, which is advantageous from the viewpoint of correcting spherical aberration and astigmatism. In addition, this configuration approximates an afocal optical system that does not have a focal point in front of a movable group, and therefore fluctuations in aberrations during focusing operations can be suppressed.

The second lens group G2 includes, in order from the object side to the image side, a positive lens L2a, a first cemented lens C2a formed by cementing a negative lens L2b and a biconvex positive lens L2c, provided in this order from the object side to the image side, together, and a second cemented lens C2b formed by cementing a biconvex positive lens L2d and a negative lens L2e, provided in this order from the object side to the image side, together.

By configuring the first cemented lens C2a such that the coupling surface thereof is concave toward the image side, the incident angles of marginal axial light rays that enter the coupling surface can be maintained small. As a result, the generation of higher order spherical aberration and longitudinal chromatic aberration can be suppressed. In addition, by configuring the second cemented lens C2b such that the coupling surface thereof is concave toward the object side, the incident angles of principal off axis light rays that enter the coupling surface can be maintained small. As a result, the generation of astigmatism and lateral chromatic aberration can be suppressed.

In the imaging lens of the present embodiment, it is preferable for the first sub lens group G1b to be constituted by five or fewer lenses. In addition, it is preferable for the second lens group G2 to be constituted by six or fewer lenses. Adopting such a configuration and suppressing the number of lenses contributes to a reduction in cost as well as miniaturization and weight reduction of the lens system as a whole.

In addition, it is preferable for Conditional Formula (1) below to be satisfied. By configuring the imaging lens such that the value of −f1/f is not less than or equal to the lower limit defined in Conditional Formula (1), the refractive power of the first lens group G1 can be prevented from becoming excessively strong. Such a configuration is advantageous from the viewpoints of correcting astigmatism and longitudinal chromatic aberration. By configuring the imaging lens such that the value of −f1/f is not greater than or equal to the upper limit defined in Conditional Formula (1), the refractive power of the first lens group G1 can be prevented from becoming excessively weak. As a result, the total length of the lens system can be prevented from becoming long. Note that more favorable properties can be obtained if Conditional Formula (1-1) below is satisfied.

5<-f1/f<39 (1)

6<-f/f<35 (1-1)

wherein f1 is the focal length of the first lens group, and f is the focal length of the entire lens system.

In addition, it is preferable for Conditional Formula (2) below to be satisfied. By configuring the imaging lens such that the value of −f1/f2 is not less than or equal to the lower limit defined in Conditional Formula (2), the refractive power of the first lens group G1 can be prevented from becoming excessively strong, or the refractive power of the second lens group G2 can be prevented from becoming excessively weak. Such a configuration is advantageous from the viewpoints of correcting off axis aberrations, such as astigmatism and distortion. By configuring the imaging lens such that the value of −f1/f2 is not greater than or equal to the upper limit defined in Conditional Formula (2), the refractive power of the first lens group G1 can be prevented from becoming excessively weak, or the refractive power of the second lens group G2 can be prevented from becoming excessively strong. As a result, the total length of the lens system can be prevented from becoming long, or securing of back focus can be facilitated. Note that more favorable properties can be obtained if Conditional Formula (2-1) below is satisfied.

1.5<-f1/f2<13 (2)

2<-f1/f2<12 (2-1)

wherein f1 is the focal length of the first lens group, and f2 is the focal length of the second lens group.

In addition, it is preferable for Conditional Formula (3) below to be satisfied. Configuring the imaging lens such that the value of (R5f+R5r)/(R5f−R5r) is not less than or equal to the lower limit defined in Conditional Formula (3) is advantageous from the viewpoint of correcting longitudinal chromatic aberration. Configuring the imaging lens such that the value of (R5f+R5r)/(R5f−R5r) is not greater than or equal to the upper limit defined in Conditional Formula (3) is advantageous from the viewpoints of correcting spherical aberration and astigmatism, or can prevent the total length of the lens system from becoming long. Note that more favorable properties can be obtained if Conditional Formula (3-1) below is satisfied.

1.2<(R5f+R5r)/(R5f−R5r)<6.5 (3)

1.3<(R5f+R5r)/(R5f−R5r)<6 (3-1)

wherein R5f is the radius of curvature of the surface toward the object side of the positive lens provided most toward the object side within the second sub lens group, and R5r is the radius of curvature of the surface toward the image side of the positive lens provided most toward the object side within the second sub lens group.

In addition, it is preferable for Conditional Formula (4) below to be satisfied. By configuring the imaging lens such that the value of f1/f1a is not less than or equal to the lower limit defined in Conditional Formula (4), the negative refractive power of the first sub lens group G1a can be prevented from becoming excessively weak. Such a configuration contributes to decreasing the diameters of the lenses. By configuring the imaging lens such that the value of f1/f1a is not greater than or equal to the upper limit defined in Conditional Formula (4), the negative refractive power of the first sub lens group G1a can be prevented from becoming excessively strong. Such a configuration is advantageous from the viewpoint of correcting spherical aberration. Note that more favorable properties can be obtained if Conditional Formula (4-1) below is satisfied.

6<f1/f1a<50 (4)

7<f1/f1a<44 (4-1)

wherein f1 is the focal length of the first lens group, and f1a is the focal length of the first sub lens group.

In addition, it is preferable for Conditional Formula (5) below to be satisfied. By configuring the imaging lens such that the value of −f2/f1a is not less than or equal to the lower limit defined in Conditional Formula (5), the negative refractive power of the first sub lens group G1a can be prevented from becoming excessively weak, or the positive refractive power of the second lens group G2 can be prevented from becoming excessively strong. Such a configuration is advantageous from the viewpoints of correcting astigmatism and distortion, or can prevent the total length of the lens system from becoming long. By configuring the imaging lens such that the value of −f2/f1a is not greater than or equal to the upper limit defined in Conditional Formula (5), the negative refractive power of the first sub lens group G1a can be prevented from becoming excessively strong, or the positive refractive power of the second lens group G2 can be prevented from becoming excessively weak. Such a configuration is advantageous from the viewpoints of correcting spherical aberration and lateral chromatic aberration. Note that more favorable properties can be obtained if Conditional Formula (5-1) below is satisfied.

3.1<-f2/f1a<3.75 (5)

3.2<-f2/f1a<3.65 (5-1)

wherein f2 is the focal length of the second lens group, and f1a is the focal length of the first sub lens group.

In addition, it is preferable for Conditional Formula (6) below to be satisfied. Configuring the imaging lens such that the value of (R2f+R2r)/(R2f−R2r) is not less than or equal to the lower limit defined in Conditional Formula (6) is advantageous from the viewpoints of correcting spherical aberration and astigmatism. Configuring the imaging lens such that the value of (R2f+R2r)/(R2f−R2r) is not greater than or equal to the upper limit defined in Conditional Formula (6) is advantageous from the viewpoint of correcting longitudinal chromatic aberration. Note that more favorable properties can be obtained if Conditional Formula (6-1) below is satisfied.

3.4<(R2f+R2r)(R2f−R2r)<6 (6)

3.4<(R2f+R2r)/(R2f−R2r)<5 (6-1)

wherein R2f is the radius of curvature of the surface toward the object side of the negative lens provided most toward the object side within the first sub lens group, and R2r is the radius of curvature of the surface toward the image side of the negative lens provided most toward the object side within the first sub lens group.

In the case that the present imaging lens is to be utilized in a severe environment, it is preferable for a protective multiple layer film coating to be administered. Further, a reflection preventing coating may be administered in order to reduce the amount of ghost light during use, in addition to the protective coating.

When this imaging lens is applied to an imaging apparatus, it is preferable for a cover glass, a prism, and various filters, such as an infrared cutoff filter and a low pass filter, to be provided between the optical system and an imaging surface Sim, depending on the configuration of the camera to which the lens is mounted. Alternatively, various filters such as low pass filters and filters that cut off specific wavelength bands may be provided among each of the lenses instead of being provided between the lens system and the imaging surface Sim. As a further alternative, coatings that have the same functions as the various filters may be administered on the surfaces of the lenses.

Next, examples of numerical values of the imaging lens of the present disclosure will be described.

First, the imaging lens of Example 1 will be described. FIG. 1 is a cross sectional diagram that illustrates the lens configuration of the imaging lens of Example 1. Note that in FIG. 1 and FIGS. 2 through 4 corresponding to Examples 2 through 4 to be described later, the left side is the object side, and the right side is the image side. In addition, the aperture stops St illustrated in FIGS. 1 through 4 do not necessarily represent the size or shape thereof, but the position of the stop along optical axes Z.

In the imaging lens of Example 1, the first lens group G1 is constituted by the first sub lens group G1a and the second sub lens group G1b.

The first sub lens group G1a is constituted by four lenses, which are, in order from the object side to the image side, a positive lens L1a, a negative lens L1b, a negative lens L1c, and a negative lens L1d. Here, the positive lens L1a contributes to correction of distortion and lateral chromatic aberration. In addition, the negative lenses L1b through L1d bear the negative refractive power of the first lens group G1 in a distributed manner, contribute to correction of spherical aberration, and also contribute to widening of the angle of view and decreasing the F number of the lens system.

The second sub lens group G1b is constituted by five lenses, which are, in order from the object side to the image side, a positive lens L1e, a positive lens L1f, a positive lens L1g, a negative lens L1h, and a negative lens L1i. Here, the positive lens L1e bears the positive refractive power which is necessary within the first lens group G1. The positive lenses L1f and L1g contribute to correction of spherical aberration, astigmatism, chromatic aberrations, etc. The negative lens L1h contributes to correction of lateral chromatic aberration by being cemented with the positive lens L1g. In addition, the negative lens L1i bears negative refractive power and contributes to correction of chromatic aberrations.

The second lens group G2 is constituted by, in order from the object side to the image side, a positive lens L2a, the first cemented lens C2a formed by cementing a negative lens L2b and a biconvex positive lens L2c, provided in this order from the object side to the image side, together, and the second cemented lens C2b formed by cementing a biconvex positive lens L2d and a negative lens L2e, provided in this order from the object side to the image side, together. Here, the positive lens L2a bears the positive refractive power of the second lens group G2 and contributes to correction of spherical aberration. The first cemented lens C2a contributes to correction of spherical aberration and longitudinal chromatic aberration. In addition, the second cemented lens C2b contribute to correction of astigmatism and lateral chromatic aberration.

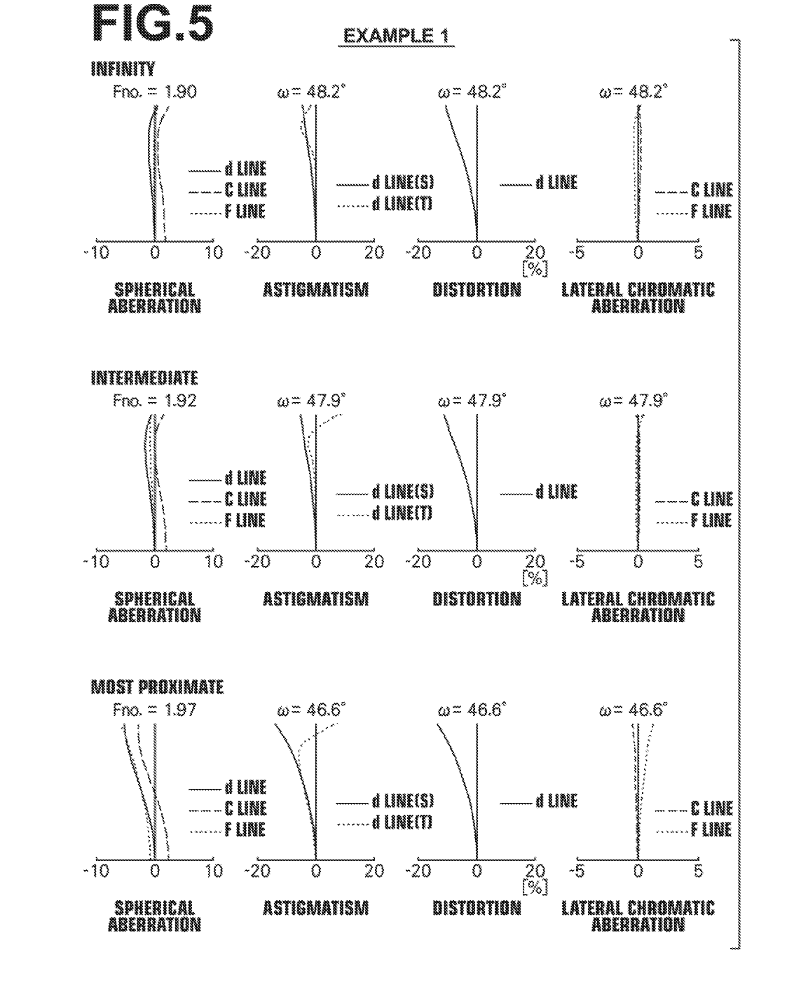

Basic lens data are shown in Table 1, data related to various items are shown in Table 2, and data related to distances among moving surfaces are shown in Table 3, for the imaging lens of Example 1. In the following description, the meanings of the symbols in the tables will be described for Example 1. The meanings of the symbols are basically the same for Examples 2 through 4. Note that the numerical values shown in Tables 1 through 13 below and the aberration diagrams of FIGS. 5 through 8 are those for a state in which the focal length of the entire lens system when focused on an object at infinity is normalized to be 1.0.

In the lens data of Table 1, surface numbers that sequentially increase from the object side to the image side, with the surface of the constituent element at the most object side designated as first, are shown in the column “Surface Number”. The radii of curvature of each of the surfaces are shown in the column “Radius of Curvature”. The distances between a surface and a surface adjacent thereto along the optical axis Z are shown in the column “Distance”. The refractive indices of each optical element with respect to the d line (wavelength: 587.6 nm) are shown in the column “nd”. The Abbe's numbers of each optical element with respect to the d line (wavelength: 587.6 nm) are shown in the column “vd”.

Here, the signs of the radii of curvature are positive in cases that the surface shape is convex toward the object side, and negative in cases that the surface shape is convex toward the image side. The aperture stop St and the optical member PP (only for Example 4) are also included in the basic lens data. Text reading “(stop)” is indicated along with a surface number in the column of the surface numbers at the surface corresponding to the aperture stop St. In addition, DD [i] is shown in the rows for distances that change when changing magnification in the lens data of Table 1. Numerical values that correspond to DD [i] are shown in Table 3.

Table 2 shows the values of the lateral magnification rate β, the focal length f′, the F number (FNo.), and the full angle of view 20) in a state focused on an object at infinity, in a state focused on an object at an intermediate distance, and in a state focused on an object at a most proximal distance, as the data related to various items.

In the basic lens data and the data related to various items, degrees are used as the units for angles. The other values are normalized, and therefore no units are employed for these values.

TABLE 1
Example 1: Lens Data

| Surface Number | Radius of Curvature | Distance | nd | vd |
|---|---|---|---|---|
| 1 | 8.28186 | 0.308 | 1.88300 | 40.80 |
| 2 | 19.89051 | 0.012 | | |
| 3 | 2.35996 | 0.123 | 1.77250 | 49.60 |
| 4 | 1.29120 | 0.443 | | |
| 5 | 2.84112 | 0.111 | 1.83481 | 42.72 |
| 6 | 1.24113 | 0.658 | | |
| 7 | −1.80492 | 0.111 | 1.95906 | 17.47 |
| 8 | 37.24613 | 0.407 | | |
| 9 | −2.46198 | 0.206 | 1.49700 | 81.54 |
| 10 | −1.56144 | 0.141 | | |
| 11 | −9.69293 | 0.155 | 1.95906 | 17.47 |
| 12 | −3.70602 | 0.996 | | |
| 13 | 4.58837 | 0.204 | 1.95375 | 32.32 |
| 14 | −9.46486 | 0.092 | 1.53775 | 74.70 |
| 15 | −12.59884 | 1.241 | | |
| 16 | −6.37009 | 0.092 | 1.53775 | 74.70 |
| 17 | 6.69275 | 0.185 | | |
| 18 (stop) | ∞ | DD [18] | | |
| 19 | 1.46115 | 0.341 | 1.43875 | 94.94 |
| 20 | −19.42805 | 0.217 | | |
| 21 | 2.71679 | 0.093 | 1.95375 | 32.32 |
| 22 | 1.00230 | 0.348 | 1.53775 | 74.70 |
| 23 | −11.92605 | 0.018 | | |
| 24 | 3.88463 | 0.300 | 1.53775 | 74.70 |
| 25 | −1.23911 | 0.339 | 1.95375 | 32.32 |
| 26 | −2.94819 | DD [26] | | |

TABLE 2
Example 1: Items (d line)

| Focus Position | Infinity | Intermediate | Proximal |
|---|---|---|---|
| β | 0 | −0.03 | −0.13 |
| f′ | 1.01 | 1.01 | 1.01 |
| FNo. | 1.90 | 1.92 | 1.97 |
| 2ω [°] | 96.4 | 95.8 | 93.2 |

TABLE 3
Example 1: Variable Distances

| Focus Position | Infinity | Intermediate | Proximal |
|---|---|---|---|
| DD [18] | 0.142 | 0.115 | 0.005 |
| DD [26] | 2.005 | 2.031 | 2.142 |

Diagrams that illustrate various aberrations of the imaging lens of Example 1 are illustrated in FIG. 5. Note that the diagrams in the upper portion of FIG. 5 illustrate spherical aberration, astigmatism, distortion, and lateral chromatic aberration in a state focused on an object at infinity from the left to the right of the drawing sheet, the diagrams in the middle portion of FIG. 5 illustrate spherical aberration, astigmatism, distortion, and lateral chromatic aberration in a state focused on an object at an intermediate distance from the left to the right of the drawing sheet, and the diagrams in the lower portion of FIG. 5 illustrate spherical aberration, astigmatism, distortion, and lateral chromatic aberration in a state focused on an object at a most proximal distance from the left to the right of the drawing sheet. The diagrams that illustrate spherical aberration, astigmatism, and distortion show aberrations related to the d line (wavelength: 587.6 nm). The diagrams that illustrate spherical aberration show aberrations related to the d line (wavelength: 587.6 nm), aberrations related to the C line (wavelength: 656.3 nm), and aberrations related to the F line (wavelength: 486.1 nm), as solid lines, long broken lines, and dotted lines, respectively. In the diagrams that illustrate astigmatism, aberrations in the sagittal direction are indicated by solid lines, while aberrations in the tangential direction are indicated by dotted lines. In the diagrams that illustrate lateral chromatic aberration, aberrations related to the C line (wavelength: 656.3 nm) and aberrations related to the F line (wavelength: 486.1 nm) are shown as long broken lines and dotted lines, respectively. Note that in the diagrams that illustrate spherical aberrations, “FNo.” F numbers. In the other diagrams that illustrate the aberrations, “o” denotes half angles of view.

The symbols, meanings, and the manners in which each item of data is shown in the description of Example 1 applies to the other Examples unless particularly noted. Therefore, redundant descriptions will be omitted hereinbelow.

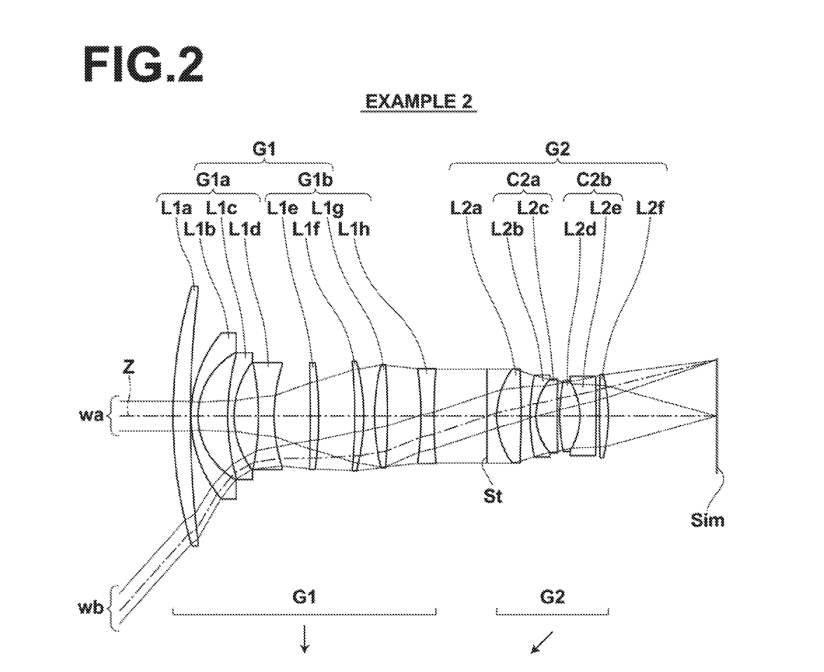

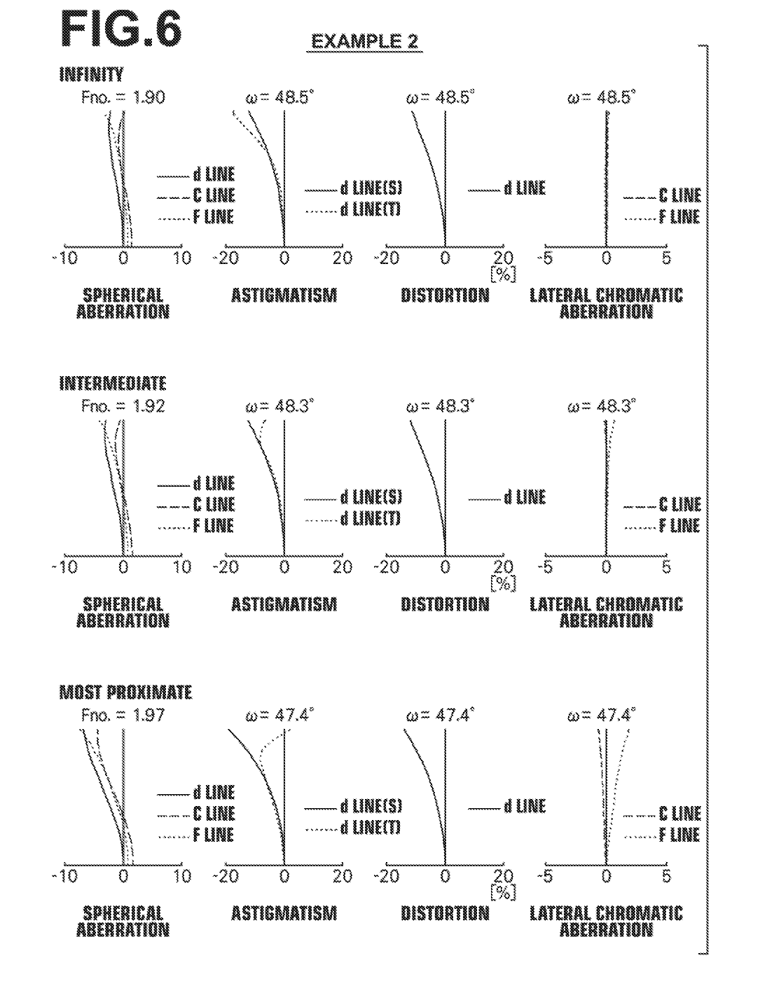

Next, an imaging lens of Example 2 will be described. FIG. 2 is a cross sectional diagram that illustrates the lens configuration of the imaging lens of Example 2. In addition, basic lens data are shown in Table 4, data related to various items are shown in Table 5, and data related to distances among movable surfaces are shown in Table 6 for the imaging lens of Example 2. Various aberrations of the imaging lens of Example 2 are illustrated in the diagrams of FIG. 6.

The imaging lens of Example 2 differs from the imaging lens of Example 1 in the configurations of a second sub lens group G1b and a second lens group G2.

The second sub lens group G1b is constituted by four lenses, which are, in order from the object side to the image side, a positive lens L1e, a positive lens L1f, a positive lens L1g, and a negative lens L1h. Here, the positive lens L1e bears positive refractive power which is necessary in the first lens group G1. The positive lenses L1f and L1g contribute to correction of spherical aberration, astigmatism, chromatic aberrations, etc. In addition, the negative lens L1f bears negative refractive power and contributes to correction of chromatic aberrations.

The second lens group G2 is constituted by, in order from the object side to the image side, a positive lens L2a, a first cemented lens C2a formed by cementing a negative lens L2b and a biconvex positive lens L2c, provided in this order from the object side to the image side, together, and a second cemented lens C2b formed by cementing a biconvex positive lens L2d and a negative lens L2e, provided in this order from the object side to the image side, together, and a positive lens L2f. Here, the operative effects of the positive lens L2a, the first cemented lens C2a, and the second cemented lens C2b are the same as those of Example 1. In addition, the positive lens L2f bears the positive refractive power of the second lens group G2 and contributes to correction of spherical aberration.

TABLE 4
Example 2: Lens Data

| Surface Number | Radius of Curvature | Distance | nd | vd |
|---|---|---|---|---|
| 1 | 8.03885 | 0.309 | 1.80400 | 46.58 |
| 2 | 18.35217 | 0.012 | | |
| 3 | 2.25597 | 0.124 | 1.69680 | 55.53 |
| 4 | 1.27825 | 0.527 | | |
| 5 | 4.05635 | 0.111 | 1.91082 | 35.25 |
| 6 | 1.56837 | 0.432 | | |
| 7 | −4.52289 | 0.276 | 1.92286 | 18.90 |
| 8 | 2.85000 | 0.644 | | |
| 9 | −26.00751 | 0.147 | 1.62588 | 35.70 |
| 10 | −7.33623 | 0.638 | | |
| 11 | −10.52051 | 0.161 | 1.89286 | 20.36 |
| 12 | −3.66874 | 0.193 | | |
| 13 | 3.74035 | 0.229 | 1.85150 | 40.78 |
| 14 | −12.62278 | 0.594 | | |
| 15 | −5.95281 | 0.232 | 1.48749 | 70.24 |
| 16 | 9.95556 | 0.941 | | |
| 17 (stop) | ∞ | DD [17] | | |
| 18 | 1.39797 | 0.429 | 1.43875 | 94.94 |
| 19 | −18.04267 | 0.163 | | |
| 20 | 3.68170 | 0.103 | 1.91082 | 35.25 |
| 21 | 0.96713 | 0.375 | 1.53775 | 74.70 |
| 22 | 49.48840 | 0.044 | | |
| 23 | 2.97002 | 0.359 | 1.53775 | 74.70 |
| 24 | −1.14172 | 0.287 | 1.91082 | 35.25 |
| 25 | −27.05976 | 0.057 | | |
| 26 | 30.60691 | 0.159 | 1.80400 | 46.58 |
| 27 | −3.08268 | DD [27] | | |

TABLE 5
Example 2: Items (d line)

| Focus Position | Infinity | Intermediate | Proximal |
|---|---|---|---|
| β | 0 | −0.03 | −0.13 |
| f′ | 1.01 | 1.01 | 1.01 |
| FNo. | 1.90 | 1.92 | 1.97 |
| 2ω [°] | 97.0 | 96.6 | 94.8 |

TABLE 6
Example 2: Variable Distances

| Focus Position | Infinity | Intermediate | Proximal |
|---|---|---|---|
| DD [17] | 0.173 | 0.147 | 0.043 |
| DD [27] | 1.924 | 1.949 | 2.054 |

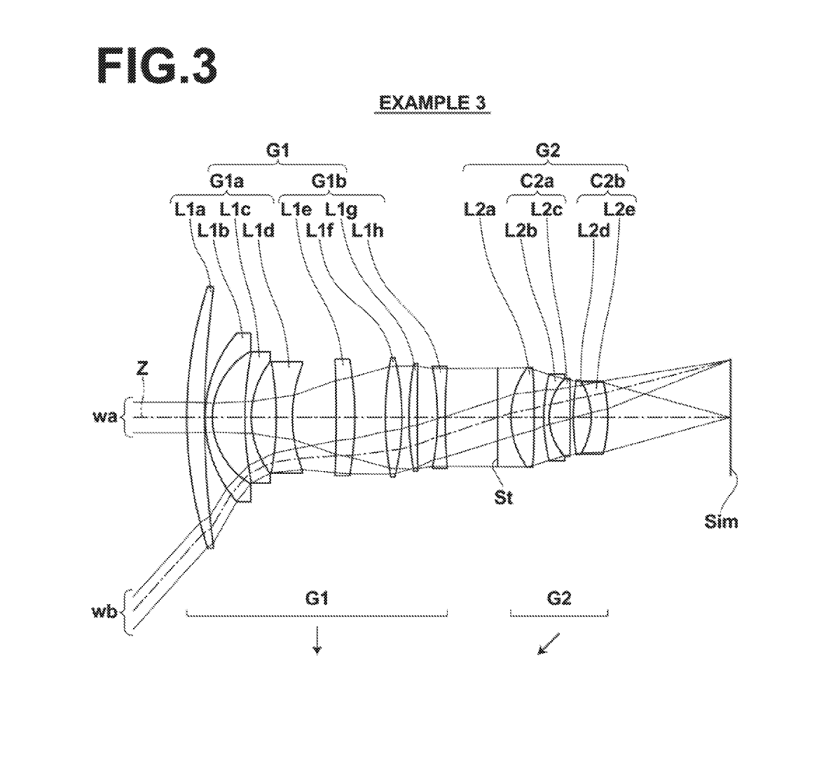

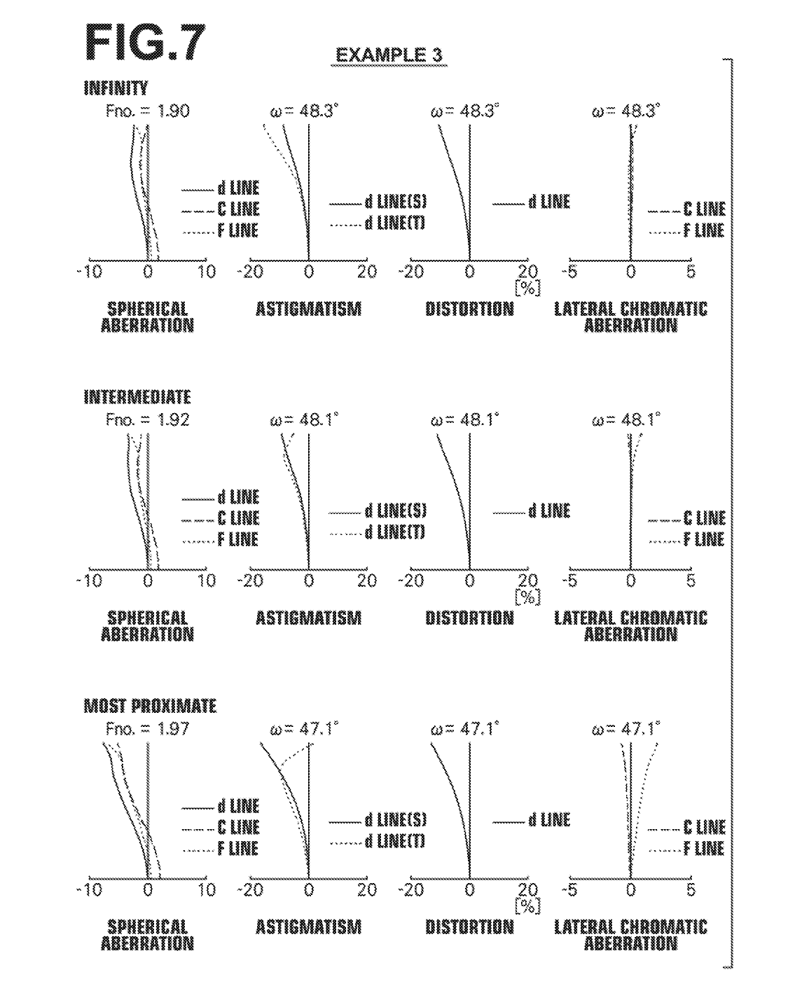

Next, an imaging lens of Example 3 will be described. FIG. 3 is a cross sectional diagram that illustrates the lens configuration of the imaging lens of Example 3. In addition, basic lens data are shown in Table 7, data related to various items are shown in Table 8, and data related to distances among movable surfaces are shown in Table 9 for the imaging lens of Example 3. Various aberrations of the imaging lens of Example 3 are illustrated in the diagrams of FIG. 7.

The imaging lens of Example 3 differs from the imaging lens of Example 1 in the configuration of a second sub lens group G1b.

The second sub lens group G1b is constituted by four lenses, which are, in order from the object side to the image side, a positive lens L1e, a positive lens L1f a positive lens L1g, and a negative lens L1h. Here, the positive lens L1e bears positive refractive power which is necessary in the first lens group G1. The positive lenses L1f and L1g contribute to correction of spherical aberration, astigmatism, chromatic aberrations, etc. In addition, the negative lens L1f bears negative refractive power and contributes to correction of chromatic aberrations.

TABLE 7
Example 3: Lens Data

| Surface Number | Radius of Curvature | Distance | nd | vd |
|---|---|---|---|---|
| 1 | 7.18685 | 0.309 | 1.78800 | 47.37 |
| 2 | 15.86834 | 0.012 | | |
| 3 | 2.19869 | 0.124 | 1.81600 | 46.62 |
| 4 | 1.31832 | 0.564 | | |
| 5 | 5.67504 | 0.111 | 1.95906 | 17.47 |
| 6 | 1.59084 | 0.433 | | |
| 7 | −5.35488 | 0.279 | 1.69680 | 55.53 |
| 8 | 2.44679 | 0.760 | | |
| 9 | −26.59690 | 0.324 | 1.64769 | 33.79 |
| 10 | −5.53059 | 0.530 | | |
| 11 | 5.71956 | 0.289 | 1.69895 | 30.13 |
| 12 | 4.27974 | 0.123 | | |
| 13 | 5.22517 | 0.144 | 1.85150 | 40.78 |
| 14 | 49.47239 | 0.352 | | |
| 15 | −4.17262 | 0.129 | 1.43875 | 94.94 |
| 16 | 9.02031 | 0.916 | | |
| 17 (stop) | ∞ | DD [17] | | |
| 18 | 1.45996 | 0.405 | 1.43875 | 94.94 |
| 19 | −14.38157 | 0.167 | | |
| 20 | 3.09261 | 0.094 | 1.95375 | 32.32 |
| 21 | 0.96911 | 0.362 | 1.53775 | 74.70 |
| 22 | −75.10875 | 0.055 | | |
| 23 | 4.09037 | 0.308 | 1.49700 | 81.54 |
| 24 | −1.20175 | 0.289 | 1.90366 | 31.31 |
| 25 | −2.58008 | DD [25] | | |

TABLE 8
Example 3: Items (d line)

| Focus Position | Infinity | Intermediate | Proximal |
|---|---|---|---|
| β | 0 | −0.03 | −0.13 |
| f′ | 1.01 | 1.01 | 1.01 |
| FNo. | 1.90 | 1.92 | 1.97 |
| 2ω [°] | 96.6 | 96.2 | 94.2 |

TABLE 9
Example 3: Variable Distances

| Focus Position | Infinity | Intermediate | Proximal |
|---|---|---|---|
| DD [17] | 0.227 | 0.201 | 0.096 |
| DD [25] | 2.129 | 2.155 | 2.260 |

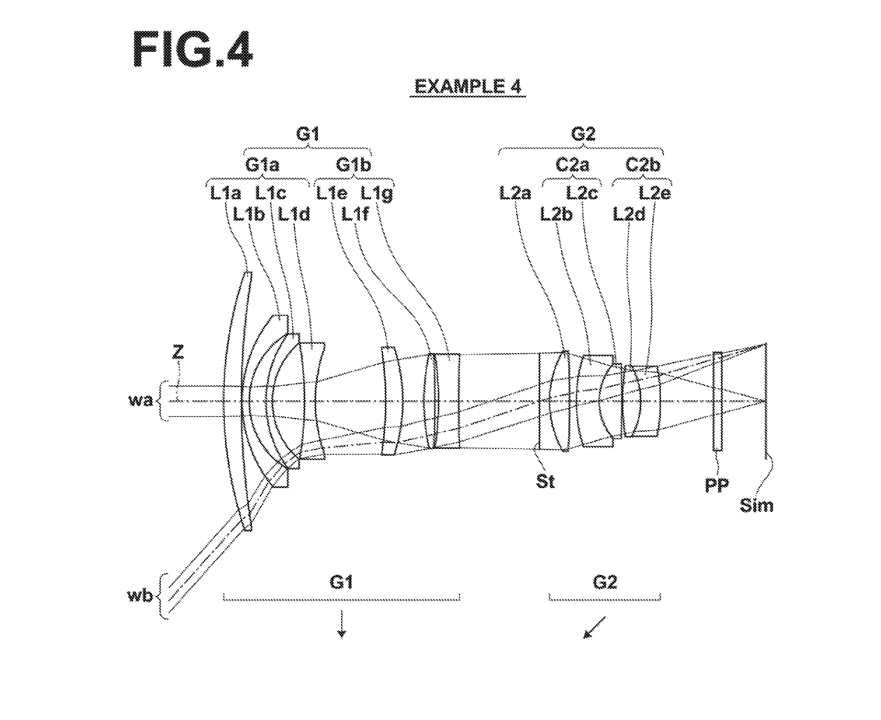

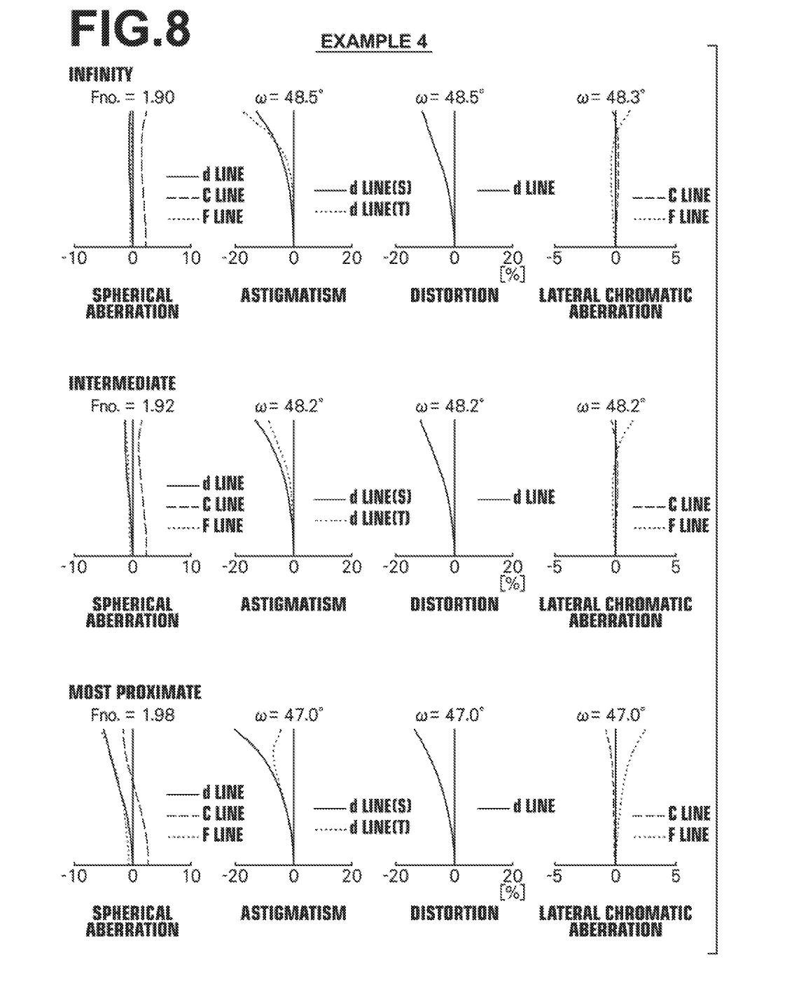

Next, an imaging lens of Example 4 will be described. FIG. 4 is a cross sectional diagram that illustrates the lens configuration of the imaging lens of Example 4. In addition, basic lens data are shown in Table 10, data related to various items are shown in Table 11, and data related to distances among movable surfaces are shown in Table 12 for the imaging lens of Example 4. Various aberrations of the imaging lens of Example 4 are illustrated in the diagrams of FIG. 8.

The imaging lens of Example 4 differs from the imaging lens of Example 1 in the configuration of a second sub lens group G1b, and that a plane parallel plate shaped optical member PP that presumes the presence of a cover glass, various filters, etc. is provided between.

The second sub lens group G1b is constituted by three lenses, which are, in order from the object side to the image side, a positive lens L1e, a positive lens L1f, and a negative lens L1g. Here, the positive lens L1e bears positive refractive power which is necessary in the first lens group G1. The positive lens L1f contribute to correction of spherical aberration, astigmatism, chromatic aberrations, etc. In addition, the negative lens L1g bears negative refractive power and contributes to correction of chromatic aberrations.

TABLE 10
Example 4: Lens Data

| Surface Number | Radius of Curvature | Distance | nd | vd |
|---|---|---|---|---|
| 1 | 6.92659 | 0.310 | 1.83481 | 42.72 |
| 2 | 13.50762 | 0.012 | | |
| 3 | 2.31351 | 0.124 | 1.91082 | 35.25 |
| 4 | 1.36140 | 0.293 | | |
| 5 | 1.96083 | 0.112 | 1.91082 | 35.25 |
| 6 | 1.32592 | 0.562 | | |
| 7 | −5.91921 | 0.189 | 1.91082 | 35.25 |
| 8 | 2.74341 | 1.227 | | |
| 9 | −6.19659 | 0.299 | 1.91082 | 35.25 |
| 10 | −2.99191 | 0.371 | | |
| 11 | 3.78505 | 0.192 | 1.85150 | 40.78 |
| 12 | −15.65712 | 0.066 | | |
| 13 | −5.07701 | 0.352 | 1.49700 | 81.54 |
| 14 | 22.76945 | 1.413 | | |
| 15 (stop) | ∞ | DD [15] | | |
| 16 | 1.74770 | 0.351 | 1.49700 | 81.54 |
| 17 | −14.90557 | 0.117 | | |
| 18 | 2.58889 | 0.399 | 1.91082 | 35.25 |
| 19 | 0.97815 | 0.391 | 1.49700 | 81.54 |
| 20 | −30.86795 | 0.019 | | |
| 21 | 4.17399 | 0.317 | 1.49700 | 81.54 |
| 22 | −1.22690 | 0.341 | 1.90366 | 31.31 |
| 23 | −3.34556 | DD [23] | | |
| 24 | ∞ | 0.143 | 1.51680 | 64.20 |
| 25 | ∞ | 0.770 | | |

TABLE 11
Example 4: Items (d line)

| Focus Position | Infinity | Intermediate | Proximal |
|---|---|---|---|
| β | 0 | −0.03 | −0.13 |
| f′ | 1.01 | 1.01 | 1.01 |
| FNo. | 1.90 | 1.92 | 1.98 |
| 2ω [°] | 97.0 | 96.4 | 94.0 |

TABLE 12
Example 4: Variable Distances

| Focus Position | Infinity | Intermediate | Proximal |
|---|---|---|---|
| DD [15] | 0.174 | 0.148 | 0.042 |
| DD [23] | 0.929 | 0.955 | 1.061 |

Values corresponding to Conditional Formulae (1) through (6) for the imaging lenses of Examples 1 through 4 are shown in Table 13. Note that all of the Examples use the d line as a reference wavelength, and the values shown in Table 13 below are those for the reference wavelength.

TABLE 13

| | | Exam- | Exam- | Exam- | Exam- |
|---|---|---|---|---|---|
| Number | Conditional Formula | ple 1 | ple 2 | ple 3 | ple 4 |
| (1) | 5.0 < −f1/f < 39.0 | 6.271 | 31.050 | 21.858 | 12.651 |
| (2) | 1.5 < −f1/f2 < 13.0 | 2.516 | 10.626 | 7.480 | 3.639 |
| (3) | 1.2 < (R5f + R5r)/ | 4.468 | 1.786 | 1.525 | 2.867 |
| | (R5f − R5r) < 6.5 | | | | |
| (4) | 6.0 < f1/f1a < 50.0 | 8.543 | 38.288 | 26.161 | 12.822 |
| (5) | 3.1 < −f2/f1a < 3.75 | 3.395 | 3.603 | 3.498 | 3.524 |
| (6) | 3.4 < (R2f + R2r)/ | 3.416 | 3.615 | 3.995 | 3.860 |
| | (R2f − R2r) < 6.0 | | | | |

From the above data, it can be understood that all of the imaging lenses of Examples 1 through 4 satisfy Conditional Formulae (1) through (6). Therefore, it can be understood that the imaging lenses of the Examples are those having wide angles of view with full angles of view when focused on an object at infinity of 96° or greater, in which various aberrations are favorably corrected.

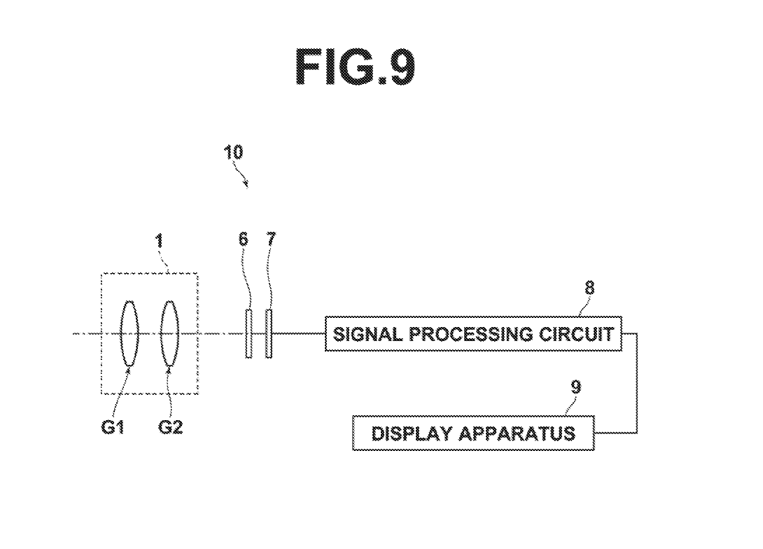

Next, an imaging apparatus according to an embodiment of the present disclosure will be described. FIG. 9 is a diagram that illustrates the schematic structure of an imaging apparatus that employs the imaging lens according to the embodiment of the present disclosure. Note that the lens groups are schematically illustrated in FIG. 9. Examples of such an imaging apparatus are a video camera and an electronic still camera that employ a solid state imaging element such as a CCD (Charge Coupled Device) and a CMOS (Complementary Metal Oxide Semiconductor) as a recording medium.

The imaging apparatus 10 illustrated in FIG. 9 is equipped with an imaging lens 1, a filter 6 having the functions of a low pass filter or the like, provided toward the image side of the imaging lens 1, an imaging element 7 provided toward the image side of the filter 6, and a signal processing circuit 8. The imaging element 7 converts optical images formed by the imaging lens 1 into electrical signals. A CCD, a CMOS, or the like may be employed as the imaging element 7. The imaging element 7 is positioned such that the image capturing surface thereof matches the imaging surface of the imaging lens 1.

Images obtained by the imaging lens 1 are formed on the image capturing surface of the imaging element 7, output signals related to the images undergo calculation processes at the signal processing circuit 8, and the images are displayed on a display apparatus 9.

The imaging apparatus 10 is equipped with the imaging lens 1 according to the embodiment of the present disclosure. Therefore, the imaging apparatus 10 is capable of obtaining images at wide angles of view having high image quality.

The present disclosure has been described with reference to the embodiments and Examples. However, the present disclosure is not limited to the above embodiments and Examples, and various modifications are possible. For example, the numerical values of the radii of curvature, the distances among surfaces, the refractive indices, the Abbe's numbers, etc. of the lens components are not limited to those exemplified in the above Examples, and may be different values.

What is claimed is:

1. An imaging lens, consisting of, in order from the object side to the image side:
a first lens group having a negative refractive power;
a stop; and
a second lens group having a positive refractive power;
the first lens group consisting of in order from the object side to the image side, a first sub lens group having a negative refractive power as a whole, consisting of one positive lens and three negative lenses, and a second sub lens group having a positive refractive power as a whole, including at least two positive lenses and at least one negative lens;
the second lens group including, in order from the object side to the image side, a positive lens, a first cemented lens formed by cementing a negative lens and a biconvex positive lens, provided in this order from the object side to the image side, together, and a second cemented lens formed by cementing a biconvex positive lens and a negative lens, provided in this order from the object side to the image side, together; and
focusing operations being performed by moving the second lens group while the first lens group and the stop are fixed with respect to an imaging surface.

2. An imaging lens as defined in claim 1, wherein:
the second sub lens group is constituted by five or fewer lenses.

3. An imaging lens as defined in claim 1, wherein:
the second lens group is constituted by six or fewer lenses.

4. An imaging lens as defined in claim 1, in which Conditional Formula (1) below is satisfied:
5<-f1/f<39 (1)
wherein f1 is the focal length of the first lens group, and f is the focal length of the entire lens system.

5. An imaging lens as defined in claim 1, in which Conditional Formula (2) below is satisfied:
1.5<-f1/f2<13 (2)
wherein f1 is the focal length of the first lens group, and f2 is the focal length of the second lens group.

6. An imaging lens as defined in claim 1, in which Conditional Formula (3) below is satisfied:
1.2<(R5f+R5r)(R5f−R5r)<6.5 (3)
wherein R5f is the radius of curvature of the surface toward the object side of the positive lens provided most toward the object side within the second sub lens group, and R5r is the radius of curvature of the surface toward the image side of the positive lens provided most toward the object side within the second sub lens group.

7. An imaging lens as defined in claim 1, in which Conditional Formula (4) below is satisfied:
6<f1/f1a<50 (4)
wherein f1 is the focal length of the first lens group, and f1a is the focal length of the first sub lens group.

8. An imaging lens as defined in claim 1, in which Conditional Formula (5) is satisfied:
3.1<-f2/f1a<3.75 (5)
wherein f2 is the focal length of the second lens group, and f1a is the focal length of the first sub lens group.

9. An imaging lens as defined in claim 1, in which Conditional Formula (6) below is satisfied:
3.4<(R2f+R2r)/(R2f−R2r)<6 (6)
wherein R2f is the radius of curvature of the surface toward the object side of the negative lens provided most toward the object side within the first sub lens group, and R2r is the radius of curvature of the surface toward the image side of the negative lens provided most toward the object side within the first sub lens group.

10. An imaging lens as defined in claim 1, in which Conditional Formula (1-1) below is satisfied:
6<-f/f<35 (1-1)
wherein f1 is the focal length of the first lens group, and f is the focal length of the entire lens system.

11. An imaging lens as defined in claim 1, in which Conditional Formula (2-1) below is satisfied:
2<-f1/f2<12 (2-1)
wherein f1 is the focal length of the first lens group, and f2 is the focal length of the second lens group.

12. An imaging lens as defined in claim 1, in which Conditional Formula (3-1) below is satisfied:
1.3<(R5f+R5r)/(R5f−R5r)<6 (3-1)
wherein R5f is the radius of curvature of the surface toward the object side of the positive lens provided most toward the object side within the second sub lens group, and R5r is the radius of curvature of the surface toward the image side of the positive lens provided most toward the object side within the second sub lens group.

13. An imaging lens as defined in claim 1, in which Conditional Formula (4-1) below is satisfied:
7<f1/f1a<44 (4-1)
wherein f1 is the focal length of the first lens group, and f1a is the focal length of the first sub lens group.

14. An imaging lens as defined in claim 1, in which Conditional Formula (5-1) is satisfied:
3.2<-f2/f1a<3.65 (5-1)
wherein f2 is the focal length of the second lens group, and f1a is the focal length of the first sub lens group.

15. An imaging lens as defined in claim 1, in which Conditional Formula (6-1) below is satisfied:
3.4<(R2f+R2r)/(R2f−R2r)<5 (6-1)
wherein R2f is the radius of curvature of the surface toward the object side of the negative lens provided most toward the object side within the first sub lens group, and R2r is the radius of curvature of the surface toward the image side of the negative lens provided most toward the object side within the first sub lens group.

16. An imaging apparatus equipped with an imaging lens as defined in claim 1.
